(19) United States
(12) Patent Application Publication
(10) Pub. No.: US 2011/0040580 A1
(43) Pub. Date: Feb. 17, 2011

(54) SYSTEM AND METHOD FOR KNOWLEDGE-DRIVEN PRESENTATION OF MEDICAL CLAIM INFORMATION

(76) Inventors: Kathleen F. Maurer, Westbrook, CT (US); Kelly J. McLaughlin, Cobalt, CT (US)

Correspondence Address: BUCKLEY, MASCHOFF & TALWALKAR LLC, 50 LOCUST AVENUE, NEW CANAAN, CT, 06840, US

(21) Appl. No.: 12/539,015

(22) Filed: Aug. 11, 2009

(51) Int. Cl. G06Q 40/00

(52) U.S. Cl. 705/4

(57) ABSTRACT

A computerized system includes acquisition of cost data associated with a workers' compensation claim from a data storage device, reception of a request to display the cost data associated with the workers' compensation claim from a remote terminal, application of knowledge-based graphing rules to the cost data to identify a medically-relevant characteristic of the cost data, and output, to a client device, of a graphical representation of the requested cost data including a graphical indication of the identified medically-relevant characteristic.

### FIELD

Embodiments relate to computer systems to view medically-related claim data. Embodiments are also concerned with efficient and useful presentation of medically-related claim data.

### BACKGROUND

Medically-related insurance claims (e.g., workers' compensation claims) involve a significant volume of associated data. This data may originate from medical bills, incoming payments, and procedure-level descriptions. Accordingly, the data may include not only cost data but also medical provider addresses, medical bill totals, incoming payment amounts, procedure codes, diagnostic codes, etc.

Conventionally, claim data is stored by disparate systems associated with disparate access tools. For example, certain tools provide access to payment details, but the details are not searchable according to payment categories and do not indicate the associated procedures. Other tools provide access to scanned documents (e.g., bills, claim forms), but do not provide electronic searching or categorization of the information contained in the documents. Still other access tools display aggregate billing data for a claim, but not procedure-level data.

Further to the foregoing shortcomings, known conventional tools for viewing claim data do not provide any information (i.e., other than the viewed claim data) that may assist in analysis of a claim associated with a particular claimant. Such analysis is crucial for determining insurance reserves, suggesting treatment options, reallocating resources (e.g., triggering a nursing assignment or physician review), and/or re-assigning the claim to a more (or less) senior adjuster.

### SUMMARY

A computer system is disclosed which includes a data storage device. Functions performed by the data storage module include receiving, storing, and providing access to claim cost data associated with a workers' compensation claim of a single claimant. Also included are a computer processor for executing program instructions and for retrieving the claim cost data from the data storage device, a memory, coupled to the computer processor, for storing program instructions for execution by the computer processor, a grouping engine, a rules engine and a communication device coupled to the computer processor.

The grouping engine includes program instructions stored in the memory for grouping the claim cost data into medical categories based on knowledge-based grouping rules, and the rules engine includes program instructions stored in the memory for applying knowledge-based graphing rules to the grouped claim cost data to identify a medically-relevant characteristic of the grouped claim cost data when executed by the computer processor. The communication device is to output a graphical representation of the grouped claim cost data including a graphical indication of the medically-relevant characteristic.

With these and other advantages and features that will become apparent, embodiments may be more clearly understood by reference to the following detailed description, the appended claims, and the drawings attached hereto.

### BRIEF DESCRIPTION OF THE DRAWINGS

FIG. 1 illustrates a system architecture within which some embodiments may be implemented.

FIG. 2 is a partial functional block diagram of a computer system provided in accordance with some embodiments.

FIG. 3 is a flow diagram of a process according to some embodiments.

FIG. 4 illustrates a hierarchical tree of medical categories according to some embodiments.

FIG. 5 is a outward view of a graphical representation according to some embodiments.

FIG. 6 is a outward view of a graphical representation according to some embodiments.

FIG. 7 is a outward view of a graphical representation according to some embodiments.

### DETAILED DESCRIPTION

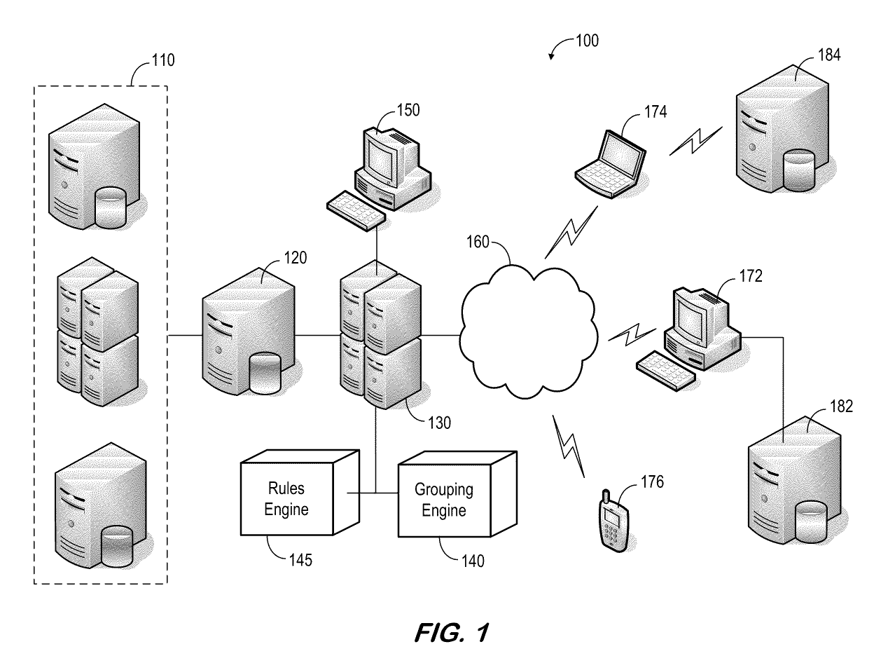

FIG. 1 illustrates system architecture 100 within which some embodiments may be implemented. Although the devices of architecture 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 1, data sources 110 receive claim cost data and other data associated with various claims such as, for example, workers' compensation claims. Each of data sources 110 may be operated by a billing entity (e.g., a hospital, a physician's office, a pharmacy), a claims processor entering data received from a billing entity, a payment-providing entity (e.g., a benefits provider, an insurance company), and/or any other suitable entity. Any number of data sources 110 may be employed to receive data according to some embodiments. The data may be generated and received using any systems that are or become known.

The claim data may include claimant identification information, a service date, a description (e.g., of a procedure or a drug), a billing code (CPT, ICD-9, Rev Codes, HCPCS), a vendor name, a cost, and/or any other data related to a claim that is or becomes known. Further examples of claim data include claimant height, claimant weight, health risks and diagnosis(es).

The claim data is received and stored by data warehouse 120. Any number or type of data storage systems may store the claim data in any suitable manner according to some embodiments. Non-exhaustive examples include a relational database system, a spreadsheet, and any other data structure that is amenable to parsing.

Application server 130 receives the claim data from data warehouse 120. Application server 130 receives the claim data directly from data sources 110, in addition to or instead of from data warehouse 120. According to some embodiments, application server 130 outputs a graphical representation of claim cost data including a graphical indication of a medically-relevant characteristic of the medical claim cost data.

More specifically, in some embodiments, application server 130 uses grouping engine 140 to group the claim cost data into medical categories, uses rules engine 145 to identify medically-relevant characteristics of the grouped data, and outputs, to a client device, a graphical representation of the requested cost data including a graphical indication of the identified medically-relevant characteristics. Briefly, such a graphical representation may include a graph of costs over time for a single claimant. The costs may be grouped according to categories such as Hospital, Physician and Pharmaceutical, and the costs of each category may be graphed separately. Moreover, the graphical representation may include a flag or other graphical indication identifying a point in time at which the total costs of the Pharmaceutical category exceeded a specified threshold. Detailed examples of graphical representations and graphical indications according to some embodiments are discussed below.

Grouping engine 140 may therefore comprise a system to execute software scripts, macros, routines, algorithms, etc. (hereinafter “rules”) for grouping the claim cost data into medical categories. The medical categories (e.g., Hospital, Physician and Pharmaceutical) may have been previously deemed useful in facilitating the analysis of a claim. The medical categories may also or alternatively comprise medical categories to which rules of rules engine 145 apply.

Rules engine 145 may comprise a system to execute rules for identifying medically-relevant characteristics of the grouped data (e.g., total Pharmaceutical costs exceeding a specified threshold). The rules and/or the groupings of medical categories may be designed and/or dynamically changed by an operator of terminal 150. Terminal 150 may also provide for management of other aspects of application server 130 and/or rules engine 145.

Grouping engine 140 and rules engine 145 may comprise any combination of hardware and/or processor-executable instructions stored on a tangible medium. According to some embodiments, one or both of grouping engine 140 and rules engine 145 are components of application server 130.

Network cloud 160 may comprise any combination of hardware devices and software protocols via which application server 130 may communicate with remote terminals 172, 174 and 176. According to some embodiments, network cloud 160 comprises the World Wide Web.

Remote terminal 172 may receive and display a graphical representation of claim cost data of including a graphical indication of identified medically-relevant characteristics of the cost data. Remote terminal 172 may be operated by an adjuster who, in response, inputs an instruction to remote terminal 172 to perform an insurance-based action (e.g., change a reserve amount) associated with the claim within reserve database server 182. The adjuster may also or alternatively suggest treatment options, forward a claim to medical personnel, forward a claim to a claim processing department, and/or re-assign a claim based on the information presented by the graphical representation.

Remote terminal 174 may receive a claim forwarded by remote terminal 172 as described above, and/or may receive a graphical representation directly from application server 130. Terminal 174 may be operated by medical personnel to provide medical services associated with the claim based on the graphical representation. Such services may be facilitated using medical applications provided by medical application server 184.

It should be noted that embodiments are not limited to the devices illustrated in FIG. 1. Each device may include any number of disparate hardware and/or software elements, some of which may be located remotely from one another. Functions attributed to one device may be performed by one or more other devices in some embodiments. The devices of system 100 may communicate with one another (and with other non-illustrated elements) over any suitable communication media and protocols that are or become known.

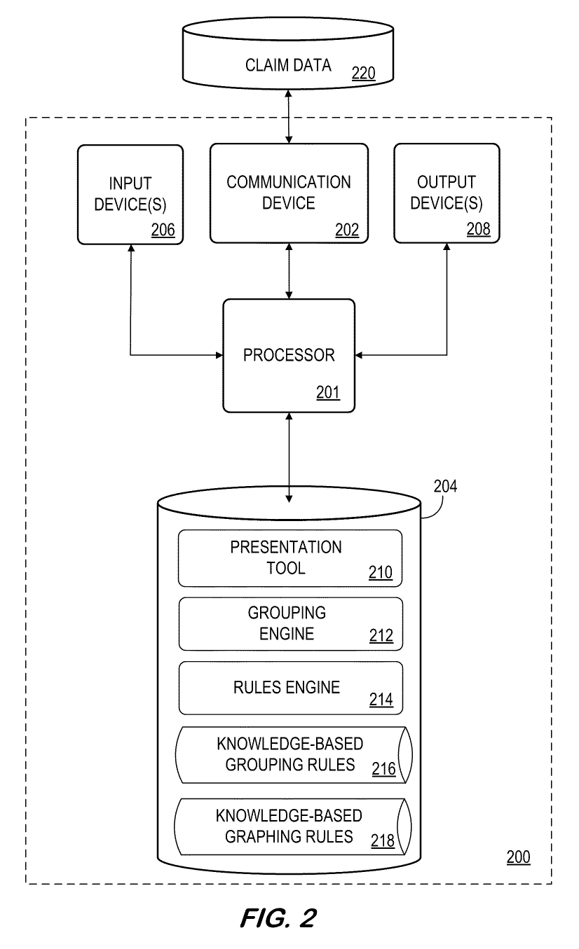

FIG. 2 is a block diagram of computer system 200 according to some embodiments. Computer system 200 may perform the functions attributed above to application server 130 and rules engine 140. Computer system 200 includes computer processor 201 operatively coupled to communication device 202, data storage device 204, one or more input devices 206 and one or more output devices 208. Communication device 202 may facilitate communication with external devices. Input device(s) 206 may comprise, for example, a keyboard, a keypad, a mouse or other pointing device, a microphone, knob or a switch, an infra-red (IR) port, a docking station, and/or a touch screen. Input device(s) 206 may be used, for example, to enter information into computer system 200. Output device(s) 208 may comprise, for example, a display (e.g., a display screen) a speaker, and/or a printer.

Data storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Data storage device 204 stores program instructions for execution by processor 200. Presentation tool 210 may comprise a set of such instructions, and may be executed by processor 201 to cause system 200 to operate as described above with respect to application server 130 of FIG. 1. This operation may include operation of communication device 202 to receive claim data, including claim cost data, stored by external data storage device 220. In some embodiments, data storage device 220 may comprise a data warehouse (e.g., data warehouse 120).

Data storage device 204 stores instructions of grouping engine 212. The instructions of grouping engine 212 may be executed by processor 201 to cause system 200 to apply knowledge-based grouping rules 216 to the claim cost data to group the claim cost data into medical categories. Such medical categories may comprise categories which have been deemed to be particularly illustrative in analyzing one or more aspects of a claim. As mentioned above, such categories may also or alternatively comprise categories on which rules engine 214 and rules 218 may operate.

In this regard, the instructions of rules engine 214 may be executed by processor 201 to cause system 200 to apply knowledge-based graphing rules 218 to the grouped claim cost data to identify a medically-relevant characteristic of the grouped data. The instructions of presentation tool 210 may then be executed to output a graphical representation of the medical cost data including a graphical indication of the medically-relevant characteristic.

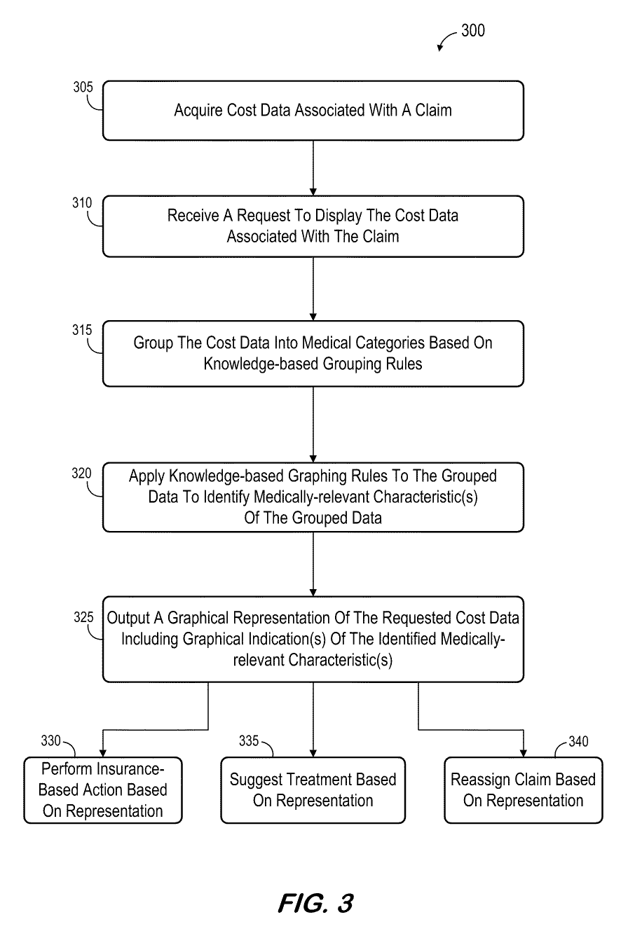

FIG. 3 is a flow diagram of process 300 according to some embodiments. Various elements of system architecture 100 and/or computer system 200 may execute process 300 according to some embodiments.

Process 300 and all other processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

Initially, at 305, cost data associated with a claim is acquired. For example, the cost data may comprise cost data associated with a workers' compensation claim that is in turn associated with a single claimant. The cost data may be acquired along with other information related to the claim. As described above, this information may include claimant identification information, a service date, a description, a billing code, and any other suitable information that is or becomes known. The data may be received from one or more of data sources 110. According to some embodiments, data warehouse 120 receives the cost data and information associated with many claims at 305 during scheduled batch download processes.

Next, at 310, a request to display cost data associated with the claim is received. The request may be received by application server 130 from one of remote terminals 172, 174 and 176 according to the present example. In this regard, the one of remote terminals 172, 174 and 176 may execute a client application (e.g., a Web browser) which allows communication with a server application of application server 130 (e.g., a Web server). The client application displays a user interface which may be manipulated to request cost data associated with a specific claim. The medical claim may be identified by a claim number or other identifier (e.g., a claimant social security number), and filters may be applied to request specific cost data to display (e.g., date range, hospital, specific procedure codes, etc.). Any user interface system for requesting data from a group of data records may be used at 310 according to some embodiments.

The request may be received prior to acquisition of the cost data associated with the claim in some embodiments. For example, application server 130 may receive such a request and, in response, may acquire the requested cost data from data sources 110. According to the present example, however, application server 130 acquires the requested data from data warehouse 120 after receiving the request at 310.

Grouping engine 140 groups the requested cost data into medical categories at 315 based on knowledge-based grouping rules. The grouping rules, and the resulting medical categories into which the cost data are grouped, may be based on scientific literature, historical medical claim data, medical expertise, claim adjusting expertise and/or professional actuarial experience. For example, the cost data for the claim may be grouped into medical categories Hospital, Physician, Pharmacy and Other. Embodiments are not limited thereto.

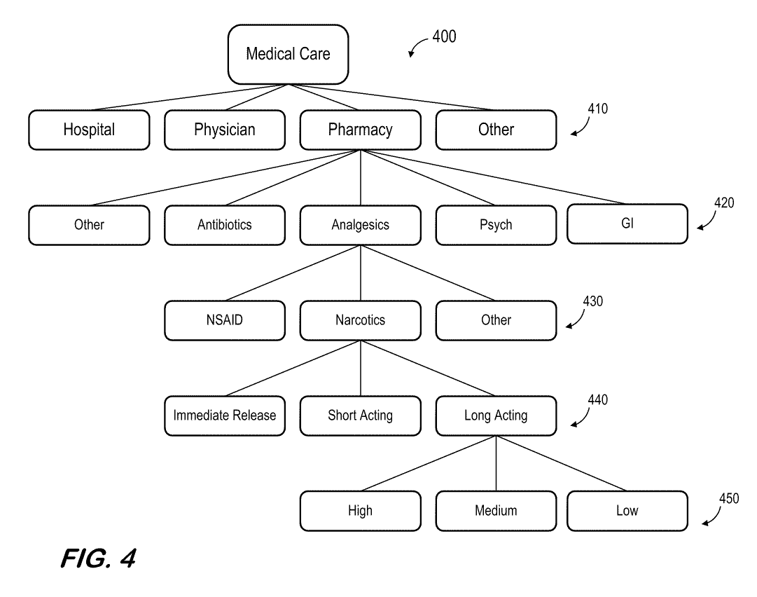

FIG. 4 illustrates hierarchical tree 400 of medical categories. The medical categories of tree 400 reflect business logic that may be developed based on one or more of the knowledge sources mentioned above. Categories 410 include “major” categories grouped by provider type. Grouping cost data into categories 410 may be deemed to provide a suitable overview of claim status.

Categories 420 comprise subcategories of the Pharmacy category which reflect relevant workers' compensation drug classes in some embodiments. Categories 430 further break down the Analgesics category into three subcategories. Again, it may have been previously determined that viewing cost data of a claim grouped according to the categories of a row of tree 400 assists in evaluation of the claim.

Continuing with tree 400, categories 440 sort the Narcotics subcategory by duration of action. Categories 450 further sort the Long Acting category according to High, Medium and Low morphine equivalency (i.e., strength multiplied by quantity). Such categories may facilitate the viewing, for example of an amount spent over time on long acting narcotics exhibiting a high morphine equivalency. Such categories may also allow the application of rules to identify medically-relevant characteristics of this amount.

According to some embodiments, the medical categories into which the cost data is grouped may be indicated within the request received at 310. More specifically, the request may specify the medical categories into which the requested cost data should be grouped for display. The specified medical categories may be selected from pre-established sets of medical categories that have previously been determined to be useful. For example, the request may specify one row of tree 400, a subset of one row of tree 400, or any combination of one or more categories of a row of tree 400.

At 320, knowledge-based graphing rules are applied to the grouped data to identify medically-relevant characteristics of the grouped data. A medically-relevant characteristic may be a trend, pattern, value, or a set thereof which indicates a medical scenario of interest (e.g., a scenario particularly relevant to proper evaluation of the associated claim). The knowledge-based graphing rules and associated medically-relevant characteristics may also be determined based on scientific literature, historical claim data, medical expertise, claim adjusting expertise and/or professional actuarial experience.

For example, the knowledge-based graphing rules may comprise a rule to identify an increase of a cost associated with a medical subcategory (e.g., Pharmacy) that is greater than a specified amount (e.g., 200%) over a specified period (e.g., one year). In other examples, a knowledge-based graphing rule identifies an increase of a medical cost associated with a medical subcategory (e.g., Hospital) over a specified period (e.g., three years).

According to some embodiments, a knowledge-based graphing rule identifies a sustained medical cost amount associated with a medical subcategory (e.g., Pharmacy) that is greater than a specified amount (e.g., $5000) over a specified period (e.g., three quarters). Another example graphing identifies a medical cost amount associated with a medical subcategory (e.g., Hospital) that is greater than a specified amount (e.g., $250,000).

A graphical representation of the requested cost data is presented at 325. The graphical representation includes a graphical indication for each identified medically-relevant characteristic. The graphical representation may be output by application server to one of remote terminals 172, 174 or 176 at 325, and displayed thereby.

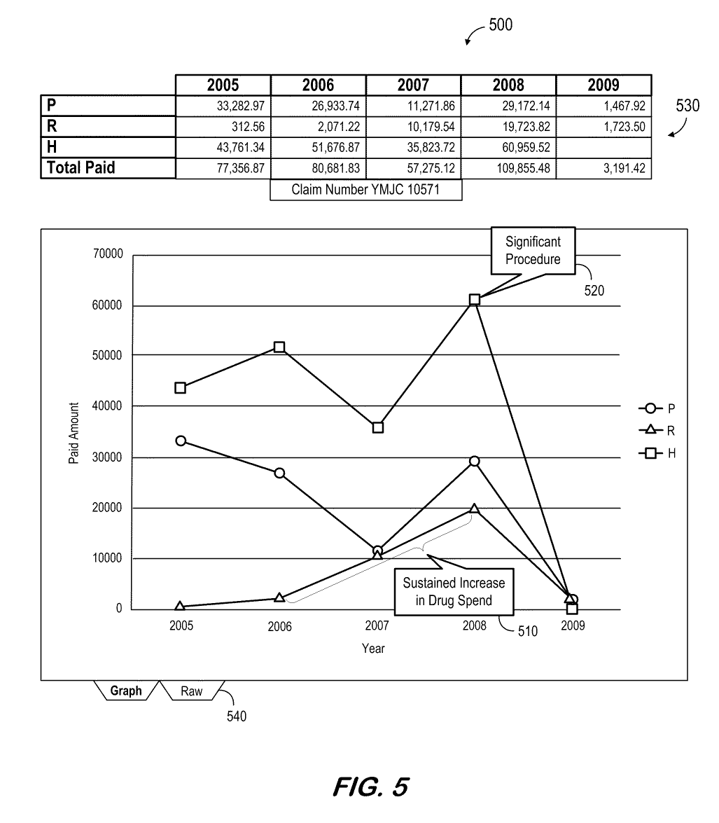

FIG. 5 is an outward view of graphical representation 500 according to some embodiments. Graphical representation 500 illustrates cost data associated with a single claimant over time for each of three medical categories (i.e., Hospital (H), Physician (P) and Pharmacy (R)). Referring to the costs associated with each medical category in 2005, the claim most likely began with a hospital procedure. Another procedure was likely performed in 2006, while physician costs dropped and pharmacy costs rose slightly. All three costs rose in 2008.

In the illustrated example, application of the knowledge-based graphing rules at 320 resulted in the identification of a sustained increase of the Pharmacy cost data between 2006 and 2008 as a medically-relevant characteristic. Accordingly, graphical representation 500 includes graphical indication 510 associated with the identified medically-relevant characteristic of the Pharmacy cost data. Application of the knowledge-based graphing rules at 320 also resulted in identification as a medically-relevant characteristic of a 2008 Hospital cost which exceeded a particular threshold (e.g., $60,000). Graphical indication 520 indicates this medically-relevant characteristic and also provides some guidance as to why the characteristic is assumed to be medically-relevant. Embodiments are not limited to the form or content of the graphical indications shown herein.

Graphical representation 500 provides table 530 of the graphed cost data. Graphical representation 500 also provides tab 540 for reviewing the raw cost data which was received at 310 and used to calculate the displayed totals. Embodiments are also not limited to the form or content of graphical representation 500 or of any other graphical representation described herein.

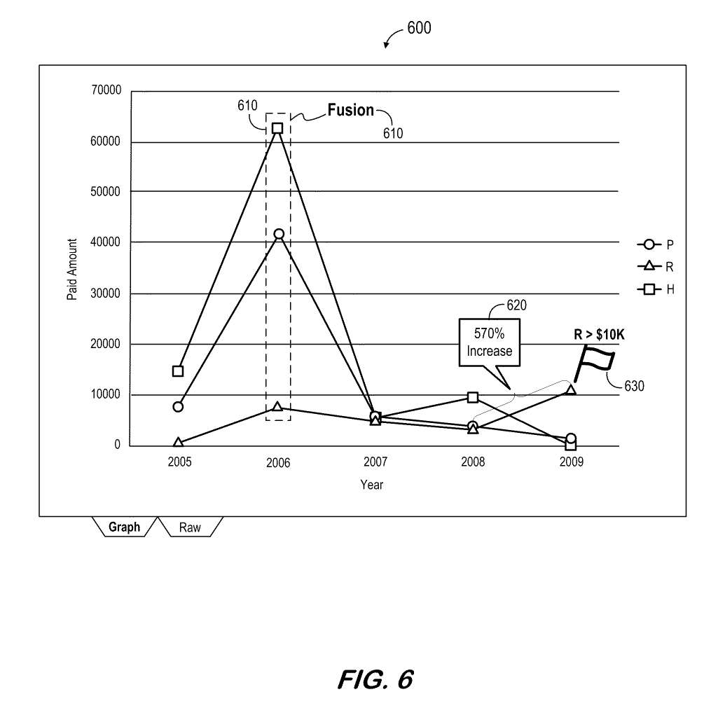

FIG. 6 is an outward view of another graphical representation 600 according to some embodiments. Again, graphical representation 600 illustrates claim cost data over time for medical categories Hospital (H), Physician (P) and Pharmacy (R), but embodiments are not limited to these categories.

Graphical representation 600 represents costs related to a spinal cord fusion. Representation 600 shows that the fusion was performed in 2006. In the present example, a knowledge-based graphing rule is applied at 320 to determine that a total cost of all three categories in a given year is greater than a specified amount and to identify this as a medically-relevant characteristic of the data. Graphical indication 610 is therefore associated with the Hospital, Physician and Pharmacy cost data of 2006, and provides a brief explanation of a medical procedure associated with the cost data of the subject year.

A rapid development of medication costs between 2008 and 2009 is also identified as a medically-relevant characteristic through application of a knowledge-based graphing rule at 320. For example, the graphing rule may be triggered by an increase in Pharmacy cost data of greater than 500% over a one year period, and result in presentation of graphical indication 620 in association with the increase. Moreover, graphical indication 630 comprises a flag indicating another identified medically-relevant characteristic (e.g., Pharmacy cost of greater than $10,000).

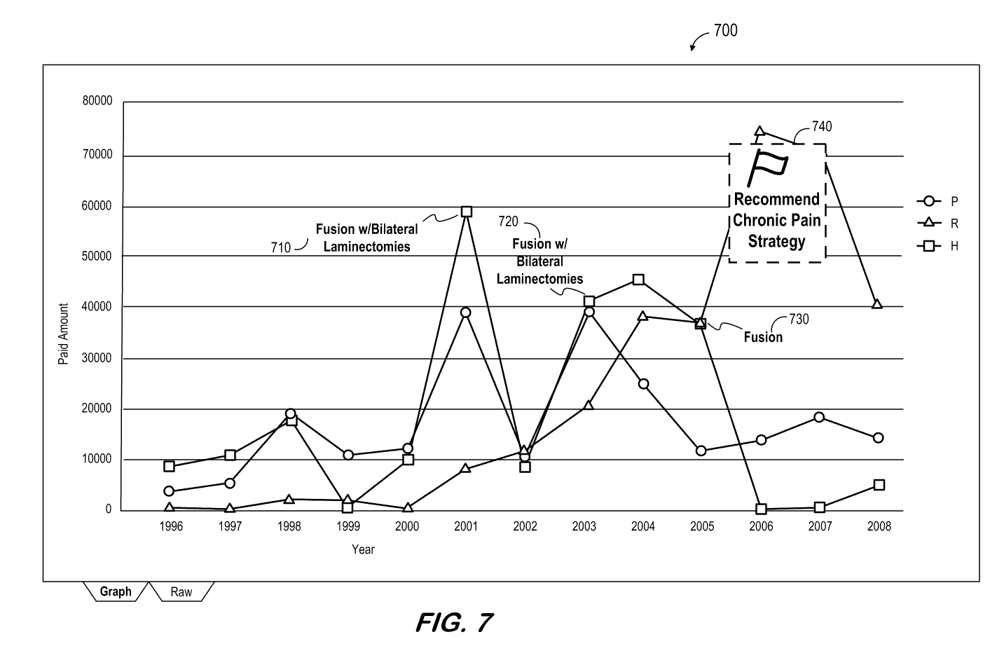

Graphical representation 700 of FIG. 7 shows medical cost data associated with a claim including multiple back surgeries. The claim develops slowly over the first few years but shows large year-to-year gradients beginning in 2001. Graphical indications according to some embodiments may assist in comprehending the gradients and/or suggesting appropriate responses thereto.

Graphical indications 710 through 730 identify characteristics which are identified by the knowledge-based graphing rules as medically-relevant to development of the claim and development of a strategy for handling the claim. These characteristics are procedures themselves, rather than cost-based trends, and are identified based on CPT codes and Rev. Codes of the claim data. Indication 740 indicates a medically-relevant characteristic identified based on the development in the Pharmacy cost data over the preceding years, and also proposes an approach based thereon.

According to some embodiments, knowledge-based graphing rules determine whether treatment of a given claim complies with a prespecified treatment standard (e.g., Official Disability Guidelines, American College of Occupational Medicine). For example, if the number of surgeries performed for a given injury is greater than that specified by a standard, this medically-relevant characteristic is indicated by a graphical indicator in a graphical representation of cost data as described above.

Returning to process 300, an adjuster or other viewer of the presented graphical representation may perform an insurance-based action based on the representation (330), suggest treatment based on the representation (335) and reassign the medical claim based on the representation (340). The presented graphical representation may improve the handling of medical claims.

The embodiments described herein are solely for the purpose of illustration. Those in the art will recognize that other embodiments may be practiced with modifications and alterations limited only by the claims.

What is claimed is:

1. A computer system comprising:
a data storage device for receiving, storing, and providing access to claim cost data associated with a workers' compensation claim of a single claimant;
a computer processor for executing program instructions and for retrieving the claim cost data from the data storage device;
a memory, coupled to the computer processor, for storing program instructions for execution by the computer processor;
a grouping engine comprising program instructions stored in the memory for grouping the claim cost data into medical categories based on knowledge-based grouping rules when executed by the computer processor;
a rules engine comprising program instructions stored in the memory for applying knowledge-based graphing rules to the grouped claim cost data to identify a medically-relevant characteristic of the grouped claim cost data when executed by the computer processor; and
a communication device, coupled to the computer processor, to output a graphical representation of the grouped claim cost data including a graphical indication of the medically-relevant characteristic.

2. A computer system according to claim 1, wherein at least one of the knowledge-based grouping rules and the knowledge-based graphing rules may be changed dynamically.

3. A system according to claim 1, wherein the claim cost data comprises payment data, medical bill data, procedure codes and diagnostic codes.

4. A system according to claim 1, the program instructions stored in the memory for receiving a request to display cost data associated with the workers' compensation claim and with one set of a plurality of sets of medical categories determined based on the knowledge-based grouping rules.

5. A system according to claim 4, wherein the knowledge-based graphing rules are applied to the cost data associated with the workers' compensation claim and the specified medical categories.

6. A system according to claim 1, wherein the medical categories comprise narcotics-immediate release, narcotics-short acting, and narcotics-long acting.

7. A system according to claim 1, wherein the knowledge-based graphing rules comprise:
a rule to identify an increase of a medical cost associated with a medical category that is greater than a specified amount over a specified period.

8. A system according to claim 1, wherein the knowledge-based graphing rules comprise:
a rule to identify an increase of a medical cost associated with a medical category over a specified period.

9. A system according to claim 1, wherein the knowledge-based graphing rules comprise:
a rule to identify a sustained medical cost amount associated with a medical category that is greater than a specified amount over a specified period.

10. A system according to claim 1, wherein the knowledge-based graphing rules comprise:
a rule to identify a medical cost amount associated with a medical category that is greater than a specified amount.

11. A system according to claim 1, further comprising:
a remote terminal to receive and to display the graphical representation to an adjuster and to receive an instruction from the adjuster to perform an insurance-based action associated with the workers' compensation claim; and
an insurance-related database to perform the insurance-based action based on the instruction.

12. A system according to claim 1, further comprising:
a remote terminal to receive and to display the graphical representation to medical personnel to receive an instruction from the medical personnel to provide information to a medical application server associated with the medical claim; and
a medical application server to initiate the medical service based on the instruction.

13. A computerized method comprising:
acquiring cost data associated with a workers' compensation claim from a data storage device;
receiving a request to display the cost data associated with the worker' compensation claim from a remote terminal;
applying knowledge-based graphing rules to the cost data to identify a medically-relevant characteristic of the cost data; and
outputting, to a client device, a graphical representation of the requested cost data including a graphical indication of the identified medically-relevant characteristic.

14. A method according to claim 13, wherein the claim cost data comprises payment data, medical bill data, procedure codes and diagnostic codes.

15. A method according to claim 13, further comprising:
receiving an instruction from a second remote terminal to dynamically change the knowledge-based graphing rules.

16. A method according to claim 13, further comprising:
grouping the claim cost data into medical categories based on knowledge-based grouping rules,
wherein the knowledge-based graphing rules are applied to the cost data to identify the medically-relevant characteristic of the cost data.

17. A method according to claim 16, further comprising:
receiving an instruction from a second remote terminal to dynamically change the knowledge-based grouping rules.

18. A method according to claim 13, wherein the request comprises a request to display the cost data associated with the workers' compensation claim and with one set of a plurality of sets of medical categories, and
wherein each of the plurality of sets of medical categories comprises a group of medical categories grouped based on knowledge-based grouping rules.

19. A method according to claim 18, wherein the knowledge-based graphing rules are applied to the cost data associated with the workers' compensation claim and the specified medical categories.

20. A method according to claim 13, wherein the medical categories comprise narcotics-immediate release, narcotics-short acting, and narcotics-long acting.

21. A method according to claim 13, wherein the knowledge-based rules comprise:
a rule to identify an increase of a medical cost associated with a medical category that is greater than a specified amount over a specified period.

22. A method according to claim 13, wherein the knowledge-based rules comprise:
a rule to identify an increase of a medical cost associated with a medical category over a specified period.

23. A method according to claim 13, wherein the knowledge-based rules comprise:
a rule to identify a sustained medical cost amount associated with a medical category that is greater than a specified amount over a specified period.

24. A method according to claim 13, wherein the knowledge-based rules comprise:
a rule to identify a medical cost amount associated with a medical category that is greater than a specified amount.

25. A method according to claim 13, further comprising:
presenting, on a remote terminal, the graphical representation to medical personnel;
receiving, at the remote terminal, an instruction from the medical personnel to perform a medical service associated with the medical claim; and
initiating, at a medical application server, the medical service based on the instruction.

26. A method according to claim 13, further comprising:
presenting, on a remote terminal, the graphical representation to an adjuster;
receiving, at the remote terminal, an instruction from an adjuster to perform an insurance-based action associated with the workers' compensation claim based on the graphical representation; and
performing the insurance-based action in an insurance database based on the instruction.

27. A computer system comprising:
a data storage device for receiving, storing, and providing access to claim cost data associated with an insurance claim of a single claimant and grouped into medical categories;
a computer processor for executing program instructions and for retrieving the claim cost data from the data storage device;
a memory, coupled to the computer processor, for storing program instructions for execution by the computer processor;
a rules engine comprising program instructions stored in the memory for applying knowledge-based graphing rules to grouped claim cost data to identify a medically-relevant characteristic of the grouped claim cost data when executed by the computer processor; and
a communication device, coupled to the computer processor, to output a graphical representation of the grouped claim cost data including a graphical indication of the medically-relevant characteristic.

28. A computer system according to claim 27, wherein the knowledge-based graphing rules may be changed dynamically.

29. A system according to claim 27, wherein the knowledge-based graphing rules comprise:
a rule to identify an increase of a medical cost associated with a medical category that is greater than a specified amount over a specified period.

30. A system according to claim 27, wherein the knowledge-based graphing rules comprise:
a rule to identify an increase of a medical cost associated with a medical category over a specified period.

31. A system according to claim 27, wherein the knowledge-based graphing rules comprise:
a rule to identify a sustained medical cost amount associated with a medical category that is greater than a specified amount over a specified period.

32. A system according to claim 27, wherein the knowledge-based graphing rules comprise:
a rule to identify a medical cost amount associated with a medical category that is greater than a specified amount.
